(19) United States
(12) Patent Application Publication
(10) Pub. No.: US 2009/0092773 A1
(43) Pub. Date: Apr. 9, 2009

(54) STAR-SHAPED DECORATIVE OBJECT

(76) Inventor: Gotz Thomas, Itzehoe (DE)

Correspondence Address: LEMPIA BRAIDWOOD LLC, 223 W. JACKSON BLVD., SUITE 620, CHICAGO, IL, 60606, US

(21) Appl. No.: 11/577,579

(22) PCT Filed: Oct. 12, 2005
(86) PCT No.: PCT/EP05/10947

§ 371 Date: Aug. 30, 2007

(30) Foreign Application Priority Data
Oct. 24, 2004 (DE) 10 2004 051 251.5

(51) Int. Cl. A47G 33/08; B23P 17/00

(52) U.S. Cl. 428/11; 29/592

(57) ABSTRACT

The invention relates to a star-shaped decorative object (2), in addition to blanks and an associated production method. The decorative object comprises at least two interconnected blanks (4,6; 58, 60; 66, 72) consisting of paper or foil, at least one (4, 6; 58, 60; 72) of which comprises a central part (12) and a plurality of points (8, 10; 74, 76) projecting onwards beyond the central part (12). The central part (12) of said blank (4, 6; 58, 60; 72) is provided with several fold lines (24) that run from a central point (26) towards the points (8, 10; 74, 76) and is folded alternately along adjoining fold lines (24) in opposite directions in a V, in such a way that between two respective fold lines (24) that are separated by an additional fold line (24), areas (44 and 40) that are folded inwards and outwards are formed with the additional fold line (24) running through their centre. To interconnect the two blanks (4, 6; 8, 60; 66, 72) to form a hollow three-dimensional body, the points (8) are pushed through openings (28; 70) of one of the other blanks (6, 4; 60, 58; 66) in areas of the folded blank (4, 6; 58, 60; 72) that are folded inwards (44).

### TECHNICAL AREA

The invention concerns a three-dimensional star-shaped decorative article or decorative object, especially for use as a Christmas window decoration or Christmas tree ornament, consisting of two or more cut-outs made of a paper or foil material, joined together, as well as a method and a set of cuts for its manufacture.

### STATE OF THE ART

Three-dimensional stars for decoration purposes during the Advent or Christmas season or as window decoration or Christmas tree ornament, produced by folding from paper blanks, are known, for example, a star marketed under the name of “Annaberg Window Star” [Annaberger Fensterstern”] or “Erzgebirg Window Star” [“Erzgebirgischer Fensterstern”] with eight closed points extending in a wreath shape over a middle part. There, on opposite sides of the star, a paper foil material is provided with sixteen radially-extending fold lines, whereby it is folded in a V-shape in opposite directions at neighboring fold lines. By means of this alternating folding, in each case, areas that are folded inward are formed between two fold lines running through the tips of neighboring points, through the middle of which a fold line extends to a re-entering corner between the two neighboring points. Conversely, the fold lines that run from the middle of each side of the star to two neighboring re-entering corners delineate outward-folded areas through the middle of which the fold lines extend to the points of the star. Similar known stars with points extending outwards radially in several directions, known under the name of “Herrenhut star” are known from DE 36 18 092 A1, from DE 90 11 320 U1, from DE 85 16 1 85 U1 or from DE 196 09 168 C2. However, to produce these stars, several blanks and/or parts must be glued together, which is only possible manually, at a relatively high cost.

Furthermore, it is known from the origami technique that two-dimensional and three-dimensional stars with a different number of points can be produced from several paper blanks merely by folding. In order to achieve the holding together of the individual blanks without glue, normally a pocket is folded into each blank into which a part of a neighboring blank is inserted and this is also relatively costly and time-consuming.

Furthermore, a decorative Christmas star is known from DE 1 735 277 U1 according to the main clause of claim 1. This folded star consists of two identical folded foil blanks joined together, each of which has a middle part as well as four longer and four shorter points extending outward beyond the middle part. Each blank is provided with eight fold lines which run from the midpoints of their middle parts to the tips of the points. The two blanks are folded in a V-shape alternately in opposite directions at the fold lines and then brought together in such a way that the midpoints of their middle parts point in opposite directions and the points are rotated by 45 degrees so that the shorter points of one blank come to lie in the recesses formed by the longer points of the other blank, resulting in a mutual strengthening of the blanks that is not described in more detail.

Based on this, the task of the invention is to provide an aesthetically pleasing star-shaped three-dimensional decorative article from two or more blanks joined together, made of a paper or foil material, as well as to provide a method and a set of blanks for its production, making it possible to produce a decorative article without gluing and at a low cost.

### PRESENTATION OF THE INVENTION

This task is solved by the invention according to the characteristics of the attached claims 1 or 21, respectively, and 32.

Surprisingly, it was found that with these characteristics it is possible to assemble two or more blanks without glue to form a stable three-dimensional star, which has an essentially closed body and points that extend wreathlike beyond the body.

The decorative article according to the invention can be used for purposes other than advent or Christmas decorations, for example as a lampshade or packaging container.

At least one of the blanks must be star-shaped and have a middle part, several points extending beyond this outward and a multiplicity of fold lines that run from a point in the middle of the middle part in the direction of the points, so that the blank can be folded alternately into a V-shape along neighboring fold lines, in opposite directions, whereby in each case, between two fold lines, separated by an additional fold line, inward-folded and outward-folded areas are formed, with the additional fold line in their middle. When only two blanks are used, the other, preferably also star-shaped blank can be flat and can have all the openings required for joining the blanks. Since, however, these blanks have a very appealing three-dimensional form only when viewed from one of their sides, and therefore are mostly used as wall or table decoration, a preferred embodiment of the invention provides that the second blank have a form similar to or preferably identical to the said first section, through which the production of the folded star can also be simplified. Then the middle part of the second blank also has several fold lines, running from a midpoint in the direction of the points and is folded alternately in opposite directions on neighboring fold lines. In order to join the two blanks, in this case the points on the inward-folded areas of one of the blanks are pushed through openings in the outward-folded areas of the other blank, as a result of which the folded star assumes an appealing three-dimensional form when viewed from either side.

The openings in the blank or blanks are expediently designed in such a way that they have a rotational symmetry with respect to the midpoint of the particular blank. When using two blanks provided with fold lines or that are folded, with alternating longer and shorter points, the openings are preferably arranged in the longer points, whereby their distance from the midpoint is preferably smaller than the distance from the tips of the shorter points and larger than the distance from the re-entering corners between the points.

When three or more blanks are used, preferably two of the blanks are folded in opposite directions along the fold lines, alternately in a V-shaped manner, while the other blank or blanks are expediently essentially flat and are introduced between the folded blanks, whereby the openings for the inward-folded regions of the folded blanks are stamped out either in one or both of the flat blanks and/or in the other folded blank.

For better explanation, within the framework of this application, an “inward” or “outward” folded area of a blank of the finished three-dimensional decorative article is understood to be an area consisting of two neighboring slanting flanks of the blank, which always extend on both sides of a fold line to the respective neighboring fold line. Hereby, the middle fold line, which divides the area into two halves, forms the baseline of a valley which has an approximately V-shaped cross-section, or the apex line of a raised part, which has an approximately V-shaped cross-section, whereby the outsides of the two flanks enclose an angle of less than 180 degrees in the first case and an angle greater than 180 degrees in the second case. Where neighboring fold lines, according to a preferred embodiment of the invention, run from the midpoint of each blank to the tips of neighboring points, each of the inward-folded or outward-folded areas extends between one fold line and the fold line after the next one. The directional statements “inward” or “outward” refer to the already folded blank, namely when looking at their raised sides, the middle parts of which, in the finished three-dimensional decorative article, form the outside of the decorative article, which will also be referred to below simply as folded star.

Since the inward-folded and outward-folded areas follow each other alternately around the midpoint of each blank that is provided with fold lines, preferably each of the outward-folded areas of each blank is provided with an opening and each of the inward-folded areas is provided with a point, which is pushed through an opening in the opposing outward-folded area of the other blank, in order to join the two blanks by interlacing with one another.

When, during the manufacture of the folded star, the two blanks, when a part of their point is being introduced into the openings of the other blank, become somewhat compressed and are, as a result, somewhat more strongly folded than before, due to the inherent elasticity of the paper or foil material, the blank has the tendency to return to a flatter, less strongly folded form. This counteracts an undesired separation of the two blanks joined together with one another and leads to a more solid seating of the points in the openings, especially when the cross-section of the opening of the latter corresponds approximately to the profile of the former. When during handling of the star pressing forces are applied onto the blanks from the outside, these spread out again, whereby the points penetrate again into the opening and thus the undesired separation of the blanks is similarly counteracted.

To prevent unintended separation of the blanks, even when opposing tensile forces are applied to these, according to a preferred embodiment of the invention, it is provided that at least some of the points are interlocked to the other blank when inserted into the openings, so that the points can no longer come loose from the opening on their own. Preferably, the interlocking is achieved by providing at least some of the points with a notch on the inward-folded areas of each blank on one or both side edges of the points, the notch holding expediently an adjoining front end of the opening. However, alternatively, the openings can also be stamped out so that one or several projections extend beyond one of their opposite bordering edges, these projections being bent over when a point is introduced and penetrates into an opening stamped out from this point when the point has been inserted into the opening as far as prescribed.

Preferably, the openings are essentially in the form of V-shaped slit openings, which are stamped out expediently near a baseline which interconnects to re-entering corners on both sides of the point. In the blanks provided with fold lines, expediently, an opening is stamped out only in every other point, whereby, in the case of blanks with alternating shorter and longer points, the opening is arranged in the longer points or in an area of the middle part bordering it, while in each case the shorter point is inserted with its tip through an opening in the other blank.

In order to facilitate the insertion of the points into the slit openings, their opposite-lying bordering edges, over the entire length or over a part of the length of the openings, can have a small distance that is expediently two or three times the thickness of the blank. The slit openings are preferably symmetrical with respect to the fold lines at the peaks of the outward-folded areas. Preferably, hereby, at least one of the two opposite bordering edges, expediently the outer bordering edge of each slit opening, is composed of two edge sections that converge in a V-shape in the direction of the fold line. The angle between the converging edge sections corresponds expediently to the angle of the cross-sectional profile of the tip of the other blank inserted through the slit opening. In order to prevent tearing of the slit openings at their front ends, these can be rounded or provided with small rounded extensions.

The thickness of the finished folded star, that is, the mutual distance of the midpoints of the two blanks, can be altered while keeping the shape of the two points essentially the same, by shifting the openings either closer to the midpoint of each blank, as a result of which the stars become thicker, or by shifting them further toward the tips of the points, as a result of which the stars become thinner. As already mentioned, the openings are preferably arranged near the foot of each point, that is, near the baseline which interconnects two neighboring re-entering corners on both sides of the particular joint.

In order to insure that the middle parts of the two blanks surround an essentially completely closed cavity, another preferred embodiment of the invention provides that the two blanks lie against one another at their reentering comers between neighboring points. Moreover, the opposite edges of each point entering through an opening are preferably formed between the front ends of this opening and the two re-entering corners adjoining the point in such a way that they correspond there to the cross-sectional form of the outward-folded area provided with the opening. In this case, the two blanks are in line-connection not only within the openings but also on both sides of it. Such a surrounding line connection between the two blanks can be achieved especially well in the case of triangular points when, on the inward-folded areas in the area of their foot, the points are somewhat narrower than or, as a maximum, exactly as wide as the points on the outward-folded areas provided with openings of each blank.

In any case, for aesthetic reasons, it may be preferable to allow gaps between the blanks in order to achieve light-and-shadow effects or to create light exit openings for a light source arranged inside the star.

The folded star according to the invention can be varied in many other ways as well, for example with regard to material, which can be tinted cardboard or transparent, translucent or opaque plastic film, but alternatively it can consist of multilayer glued colored transparent Chinese paper or a metal foil; the material thickness or area weight of the blanks, which are preferably in the range of 0.25 mm to 2 mm or 50 g/m² to 400 g/m², depending on the material; the surface properties of the visible surfaces of the star, which can be smooth, rough or embossed; possible coatings on all or a part of the surfaces, for example glitter, metallization, gold or silver spray; breakthroughs or perforations in the blanks; as well as, naturally, the three-dimensional shape of the star, which can be adapted to satisfy almost any taste by changing the number of points, for example 6, 8, 10, 12, etc. the length of the points, the arrangement of longer and shorter points or differing lengths of the longer points, the projecting length of the shorter points, the shape of the individual points, for example with straight, zig-zag or wavy edges or double tips on all or of a part of the points, the proportions of the stars, that is, the thickness-to-length ratio of the points as well as the size of the star.

Preferably, the fold lines extend out from the midpoint of the middle part to the tips of the points, however, they can also end closer to the midpoint, for example at the foot of the points or at the openings, as a result of which, especially in the area of the points instead of the V-shaped profiled cross-sections, U-shaped profiled cross-sections result. Expediently, the fold lines are directed radially, but they can also be bent in a slightly spiral form. In case of points with double tips, the fold lines can end between the two tips. Generally, within the framework of the present invention, the fold line is understood to mean a line that facilitates the folding of the blanks and it is preferably a stamped groove or a row of perforations.

Furthermore, two blanks of different color or blanks with differently-colored flat surfaces can be used, as a result of which, in the former case, looking at it from one side, points arranged next to one another have different colors, while in the latter case additionally the colored stars themselves have different colors when looked at from the opposite sides. When a transparent film material is used, the fold lines facing away from the user can be seen through the other blank, by means of which the three-dimensional effect can be further enhanced. Furthermore, especially for the blanks of larger folded stars, a translucent material can also be used and a light source can be placed inside the folded star, which illuminates both middle parts from the inside. Especially beautiful lighting effects can be achieved when the two blanks do not lie tightly against one another near the openings or if the points pushed through the openings are provided with small cut-outs or perforations in front of the openings. Then the light from the inside of the folded star can fall through the gap between the blanks or through the cut-outs or perforations onto the tips of the other blank neighboring the openings and can illuminate these from the outside while the rest of the folded star emits light from within.

Expediently, the light source is an incandescent light bulb connected to a power source through at least one cable, which is led out from the inside of the folded star expediently in the area of two neighboring re-entering corners of the two blanks, and which can also be used to hang the folded star. Furthermore, the folded stars according to the invention can also be applied around the incandescent lights of a string of lights. Hereby, one can use a cable of the string of lights for hanging, guiding it inside the star between two neighboring points and leading it out again from it between two other neighboring points. Alternatively, one of the blanks can have an opening in the middle for a light socket of the incandescent light which is plugged into a mounting of the light through the opening, whereby the blank is clamped in-between the socket and the mounting.

An especially interesting appearance of the folded star is obtained also when all or part of the points are folded reversed in the outward-folded areas on the far side of the openings, so that at least some of the openings are delineated by an outward-folded area on their inner bordering edges and by an inward-folded tip of the point at their outer bordering edges. The outward-folded areas on the inner side of each opening and the inward-folded tips on their outside are joined hereby expediently by two thin material bridges preferably bordering the outsides of the openings. Using such an arrangement, the introduction of the points into the openings can also be facilitated during the assembly of the two blanks because the openings will open fairly wide in this way without having an adverse influence on the holding together of the finished folded star.

The hanging of the folded star is preferably carried out with the aid of a loop of thread that is preferably attached to one of the longer points provided with an opening, whereby, expediently, either it is glued onto the inward-folded side of its tip or it is threaded through two round openings connected to the side edges of the blank by cut-outs.

In order to produce the decorative article according to the invention, first two or three blanks are stamped out from a paper or foil material, of which at least one has a middle part, a multiple number of points extending beyond the middle part and a number of fold lines, preferably corresponding to the number of points, the fold lines running from a midpoint of the middle part outward in the direction of the points, so that, after stamping out, this blank can be folded on adjacent fold lines in a V-shaped manner, alternately in opposite directions. Hereby, in each case, between two fold lines separated by another fold line, inward-folded and outward-folded areas are formed, respectively, with the other fold line in the middle. At least one of the other blanks is provided with a number of openings in the stamping out process, through which the tips of the points of the folded blank can be inserted in order to interconnect the two blanks. Preferably, two identical blanks are used, both of which are provided with shorter points in the inward-folded areas and with longer points in the outward-folded areas and in which openings are stamped out along the fold lines to the tips of the longer points, through which openings the points at the inward-folded areas of the other blank can be inserted in order to interconnect the two blanks.

During machine production, this last step is preferably performed simultaneously for all points inserted through an opening, by first bringing both blanks into a position in which the points at the inward-folded areas of each blank lie against the openings in the outward-folded areas of the other blank, before being shifted towards one another along a line running through their midpoint, whereby first the points enter into the opening and then, by means of a further approach, the blanks become somewhat spread out in order to anchor the points in the openings.

### BRIEF DESCRIPTION OF THE FIGURES

The invention will be explained below with a few practical examples shown in the drawing. The following are shown:

FIG. 1 is a front view of an eight-point folded star according to the invention;

FIG. 2 is a view from the back of the folded star from FIG. 1;

FIG. 3 is a view of the folded star from FIG. 1 at a slant from front and above

FIG. 4 is a side view of the folded star from FIG. 1;

FIG. 5 is a sectional view of the folded star of FIG. 1 without hanger along line V-V in FIG. 1;.

FIG. 6 is a top view onto a blank for the two halves of the folded star from FIG. 1

FIG. 7 is a side view of a first variation of the folded star;

FIG. 8 is a front view of another variation of the folded star;

FIG. 9 is a front view of a ten-point folded star;

FIG. 10 is a front view of a six-point folded star;

FIG. 11 is a top view onto a blank for the two halves of the folded star from FIG. 10;

FIG. 12 is a partially cut-away front view of the folded star from FIGS. 1 to 5 with illumination;

FIG. 13 is a front view of a folded star from a folded blank provided with fold lines and a flat blank;

FIG. 14 is a perspective side view of the folded star from FIG. 13;

FIG. 15 is a view from the back of the folded star from FIG. 13;

FIG. 16 is a top view onto the blank, provided with fold lines, of the folded star from FIGS. 13 to 16;

FIG. 17 is a top view onto the flat blank of the folded star from FIGS. 13 to 16;

FIG. 18 is a sectional view of the folded star from FIGS. 1 to 5 with illumination.

### PREFERRED EMBODIMENTS OF THE INVENTION

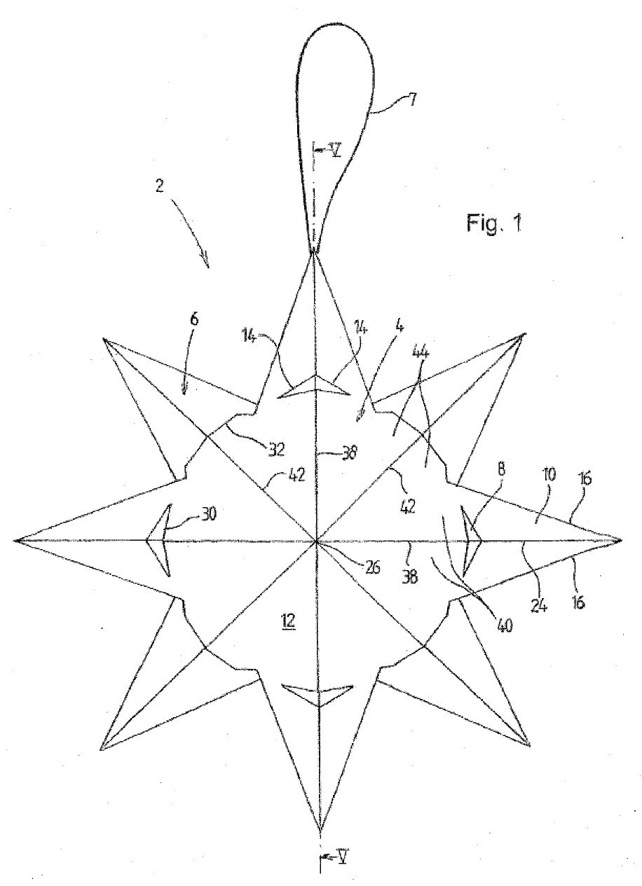

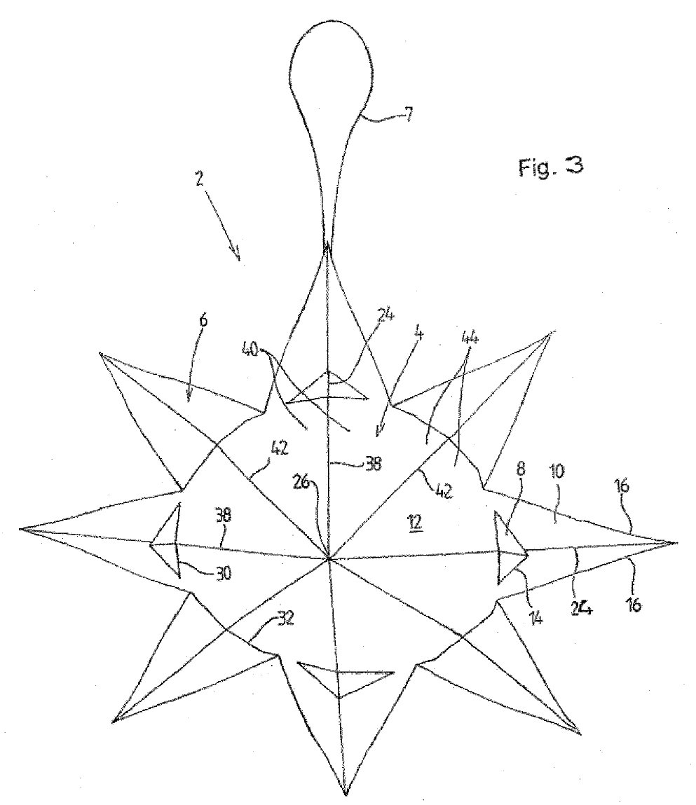

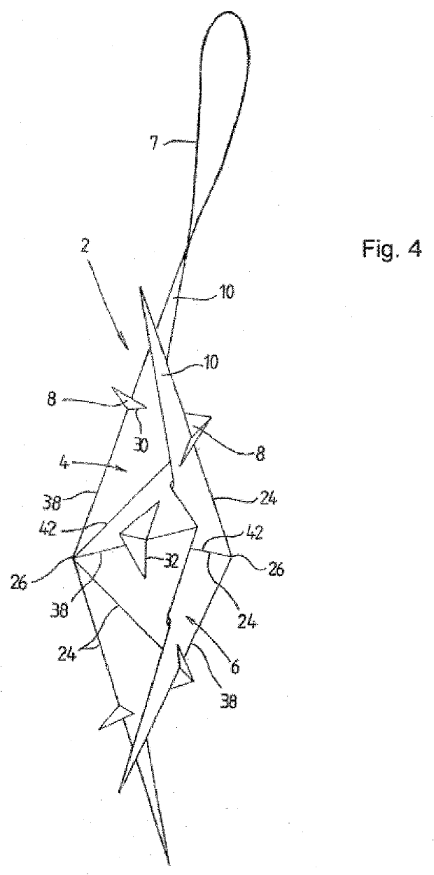

The folded stars 2 shown in FIGS. 1 to 12 consist of two identical blanks 4, 6 stamped out from cardboard or plastic film, folded and then assembled together, as well as of a loop made of thread 7 serving as hanger.

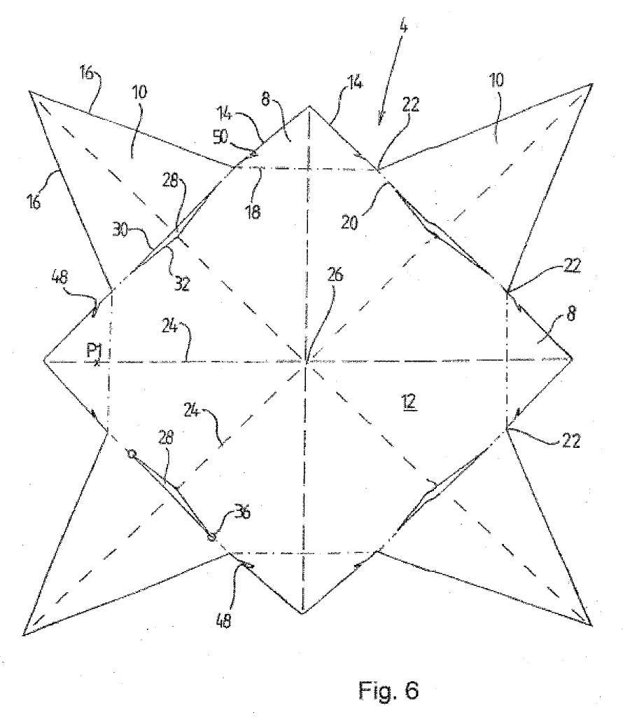

As depicted best in FIG. 6 based on the example of blank 4, each of the two blanks 4, 6 of the folded star 2 shown in FIGS. 1 to 5 has the shape of a flat eight-point star with four smaller points 8 and four larger points 10, which project outward beyond an eight-cornered middle part 12 and which are in each case delineated by two straight converging side edges 14 and 16, respectively. The middle part 12 is bordered toward the outside by imaginary baselines 18, 20, which, at the foot of each point 8, 10 connect the two re-entering comers 22 bordering the points 8, 10, as it is shown in FIG. 6 by the dash-dot lines.

When the blanks 4, 6 are stamped out of tinted cardboard or printed cardboard, these expediently have an area weight of at least 100 g/m², better still greater than 120 g/m² and best of all greater than 130 g/m² in order to obtain a finished folded star 2 with sufficient stiffness. When using colored or printed plastic film, depending on the size of the star, this has a thickness of at least 0.1 mm, better still at least 0.2 mm and best of all at least 0.25 mm.

Already during stamping, the blanks 4, 6 are provided with a total of four embossed, pressed or perforated fold lines 24, which always connect the tips of two opposite points 8, 10 with one another and all of which intersect in the middle of middle part 12 at a point 26. Moreover, during the stamping out, each of blanks 4, 6 is provided with four slit openings 28 that are arranged near the baseline 20 of each larger point 10, whereby they are directed essentially transversely to the fold lines 24 running from the midpoint 26 to the tips of the larger points 10 and are symmetrical to the fold lines 24. In the blank 4 shown in FIG. 6, at their outer side facing the tips of points 10, the slit openings 28 have a straight bordering edge 30 lying on the baseline 20, while the bordering edge 32 on the inner side of the slit openings 28 is composed of two halves or edge sections which diverge outward at an obtuse angle. Alternatively, also both bordering edges 30, 32 can have diverging edge sections. The outer bordering edges 30 of slit openings 28 are at a distance from midpoint 26 that is smaller than the distance between the midpoint 26 and a point P1 on the fold lines 24 of the smaller points 8, at which the width of the smaller points 8 corresponds approximately to the width of the slit openings 28. In order to prevent future tearing of the cardboard or of the plastic film, at the front end of slit openings 28, these front ends can be provided with small circular extensions 36, as is indicated in a somewhat enlarged form at one of the slit openings 28 in FIG. 6.

During the folding of blanks 4, 6 following the stamping out, these are nicked or folded along the fold lines 24 between the tips of the larger points 10 in one direction and along the fold lines 24 between the tips of the smaller points 8 in the opposite direction, so that upon looking at it in the peripheral direction along baselines 18, 20, a flat, zig-zag shaped folding is obtained.

If one looks at the raised, wide side area of a folded blank 4, 6, which, in the area of the middle part 12, forms the subsequent outside of the folded star 2, then each of the fold lines 24 between the tip of a larger point 10 and the midpoint 26 forms the apex line 38 of an outward-folded area 40. This outward-folded area 40 consists of two slanting flanks bordering one another along the apex line 38, extending from there in each case to the neighboring fold line 24 and forming a V-shaped raised part, whereby their outsides enclose an angle larger than 180 degree. Conversely, each of the fold lines 24 between the tip of a smaller point 8 and the midpoint 26, when viewed from the subsequent outside of the folded star 2, forms the baseline 42 of an inward-folded area 44, which is composed of two slanted flanks bordering each other along baseline 42 and which extend from the baseline 42 to the respective neighboring apex line 38 and form a valley with a V-shaped cross-section, whereby their outsides enclose an angle smaller than 180 degree. Each of the two flanks of the outward-folded areas 40 at the same time forms a flank of an inward-folded area 44 neighboring it in the clockwise or counterclockwise direction. In other words, the fold lines 24 meeting at midpoint 26 delineate pairwise areas 40, 44 having V-shaped cross-sections that are folded inward and outward, alternately.

Next, the two folded blanks 4, 6 are aligned so that, first of all, the midpoints 26 of their middle parts 12 point in opposite directions and lie on a common line, which is perpendicular to the planes defined by the tips of the longer points 10 or by the tips of the shorter points 8 or by the re-entering comers 22 between points 8, 10, and that, secondly, opposite each larger point 10 of a blank 4, there is a smaller point 8 of the other blank 6; that is, the two blanks 4, 6 are rotated by 45 degrees with respect to one another around the line through the midpoints 26. Furthermore, the two blanks 4, 6 are briefly folded more strongly by reducing the angle between the outsides of the flanks of the inward-folded areas 44, until the tips of the smaller points 8 of each blank 4, 6 are positioned accurately at the middle of the slit openings 28 of the respective other blank, 6, 4. This is always possible, at least when the midpoint angle between two neighboring fold lines 24 of the blanks 4, 6 are all the same and the tips of the smaller points 8 as well as the centers of the slit openings 28 lie on the fold lines 24.

Then the two blanks 4, 6 are moved towards each other along the lines through the midpoints 26 of the middle parts 12 until the smaller points 8 enter with their tips into the slit openings 28 of the larger points 10 and penetrate into these simultaneously until their side edges 14, which diverge to the middle part 12, contact the front ends of the slit openings 28. Then the two blanks 4, 6 become slightly spread out by enlargement of the angle between the outsides of the flanks of the inward-folded areas 44, while the smaller points 8 penetrate further into the slit openings 28 until they project a little distance with their tips beyond the other blank 6, 4 on the opposite side of the folded star 2. The spreading of the blanks 4, 6 leads to their mutual interconnection because hereby the distance between the tips of the smaller points 8 and the line through the midpoints 26 of the middle parts 12 of the two blanks 4, 6 increase faster than the distance between these lines at the slit openings 28 in the outward-folded areas 40.

When, during transportation or handling, pressing forces are applied to the middle parts of the two blanks 4, 6 of the completed folded star 2, this also leads to the spreading of the blanks 4, 6, through which, the smaller points 8, to the extent it is still possible, move a few millimeters further into the slit openings 28. Therefore, the holding together of the two blanks 4, 6 is not harmed by the pressing forces, but, on the contrary, it is improved. If a pressing force is applied to a smaller point 8 that projects through a slit opening 28, due to the interlacing of the blanks 4, 6 at the other points 8, 10, this does not lead to the removal of the point 8 from the slit opening 28 either. However, if the need arises, the two blanks 4, 6 of the folded star 2 can be separated by gripping them in the area of their middle parts 12 and pulling them apart. However, this can also be prevented by assuring that upon introduction of the points 8 into the slit openings 28, these interlock with the latter. For this purpose, the smaller points 8 are provided with small notches or cut-outs 48 on their opposite side edges 14, as shown in FIG. 6. With these notches or cut-outs 48, the opposite front ends of the slit openings 28 engage when the points 8 are introduced as far as possible into the slit openings 28. The notches or cut-outs 48 are arranged in a region of points 8 where these have essentially the same width as the slit openings 28. The notches or cut-outs 48 are designed so that, together with the side edges 14 of the points 8, they form small barbs 50, which can interlock at the front ends of the slit openings 28. Entry of these barbs 50 through the slit openings 28 when the respecting point 8 is introduced is achieved due to the fact that the point 8 deforms somewhat in the slit opening 28.

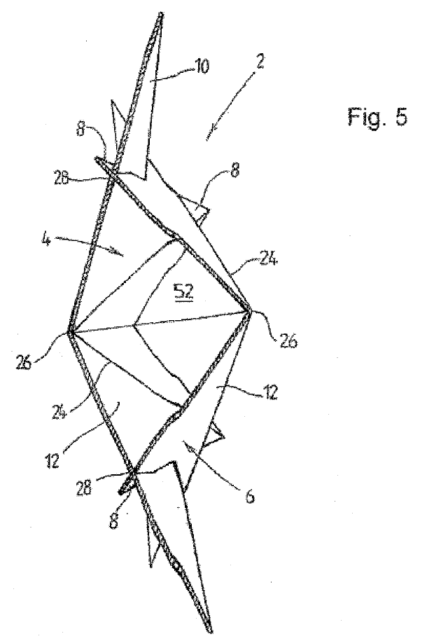

After the joining of the two blanks 4, 6, their middle parts 12 enclose a cavity 52 (FIG. 5) in the form of a polyhedron, which has almost closed peripheral contacting lines, due to the opposed positioning of the two blanks 4, 6, on both sides of each slit opening 28 and in the region of the re-entering corners 22, when the blanks 4, 6 have approximately the sizes or size relationships shown in the drawing. In these blanks 4, 6, the smaller points 8 at the inward-folded areas 44, are, on the one hand, shorter and in the area of their baseline 18 somewhat narrower than the larger points 10 at the outward-folded areas 40. On the other hand, their side edges 14 are approximately flush with baselines 20 of the adjoining larger points 10. Thus the side edges 14 of the smaller points 8 and the baselines 20 of the larger points 10 approximately delineate a polygon in which the number of corners corresponds to half of the number of points 8, 10 of the blanks 4, 6. However, by changing the dimensions of the larger or longer and of the smaller or shorter points 8, 10, respectively, that is, their width and length as well as their relationships of length to breadth, folding stars 2 can also be produced in which the blanks 4, 6 do not lie against one another on either side of the slit openings 28 or do so only in sections.

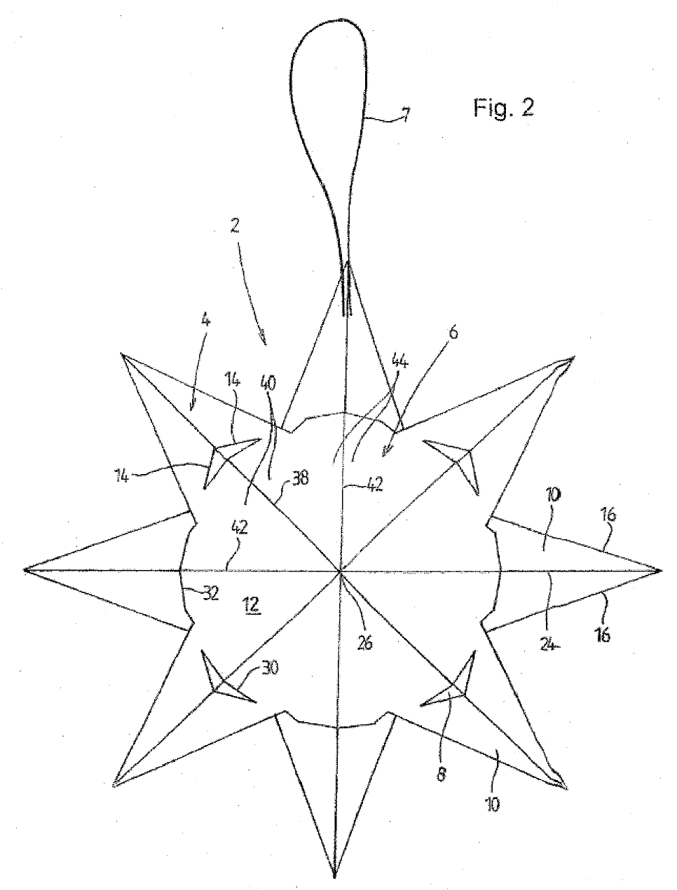

Moreover, the tips of the V-shape-folded shorter points 8 of each blank 4, 6 extend through the slit openings 28 in the longer points 10, whereby on the opposite side of the folded star 2 they project slightly beyond the V-cross-section, outward-folded areas 44 of the other blank 6,4, in each case. However, in comparison to the longer points 10, they are visually less pronounced, so that when viewing the front or back of the folded star 2, an impression of an eight-point star is obtained, as shown in FIG. 1 and FIG. 2.

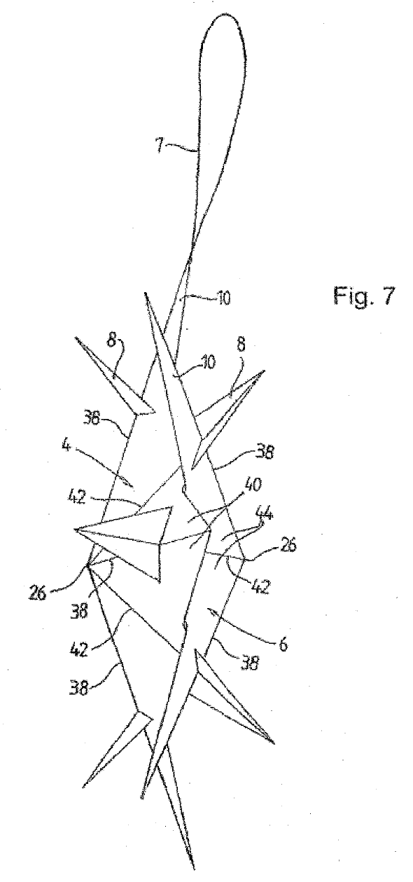

However, if desired, the size of the projection of points 8 beyond the slit openings 28 can be enlarged by the lengthening and narrowing of the shorter points 8 to such an extent that, on the other side of the slit openings 28, these will have the same or similar length as the other points 10, through which, at least when viewed from the side, the impression of a folded star 2 with a larger number of points 8, 10 is obtained, as shown in FIG. 7. The thickness of the folded star 2, that is, the distance between the midpoints 26 of the middle part 12 of the two blanks 4, 6, can be changed too, for example by placing the slit openings at a smaller or larger distance from the midpoint 28. Especially well-proportioned flat three-dimensional folded stars 2 are obtained when the slit openings 28 are arranged approximately radially outward from the baselines 20 of the larger points 10.

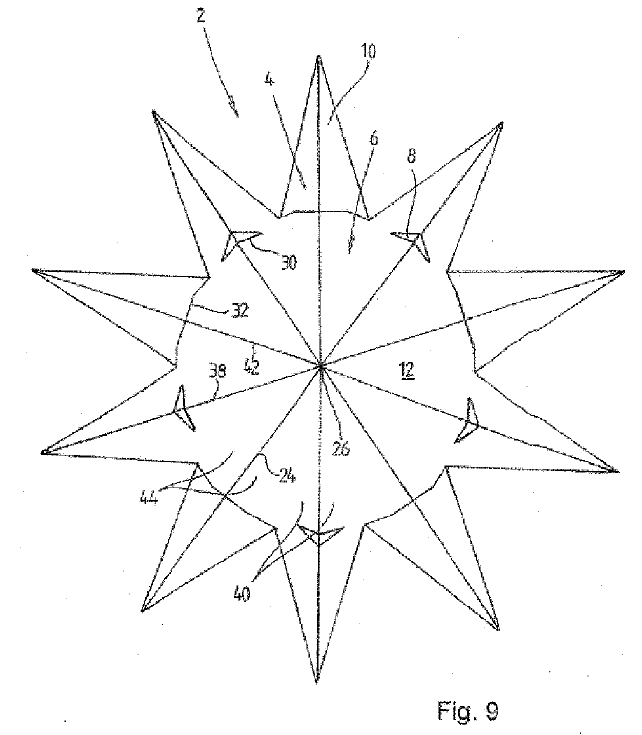

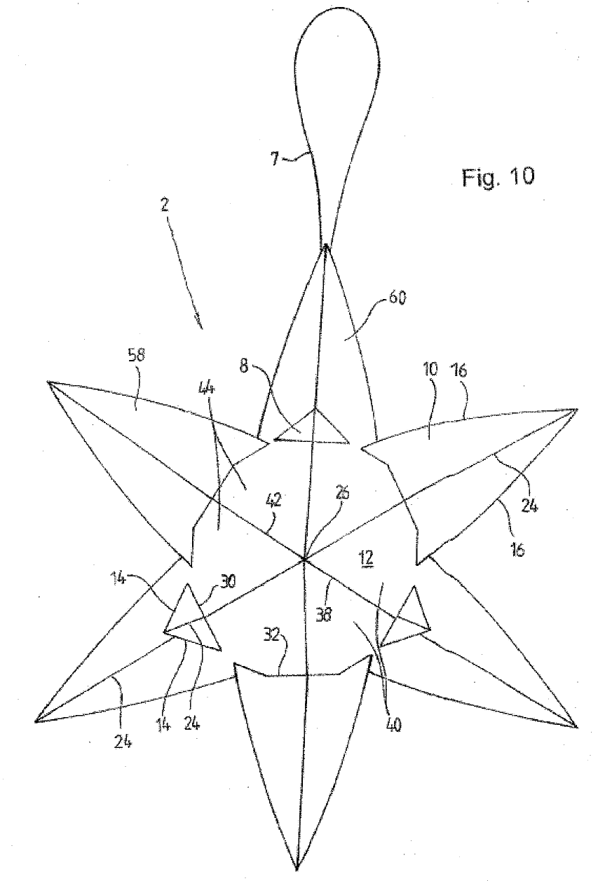

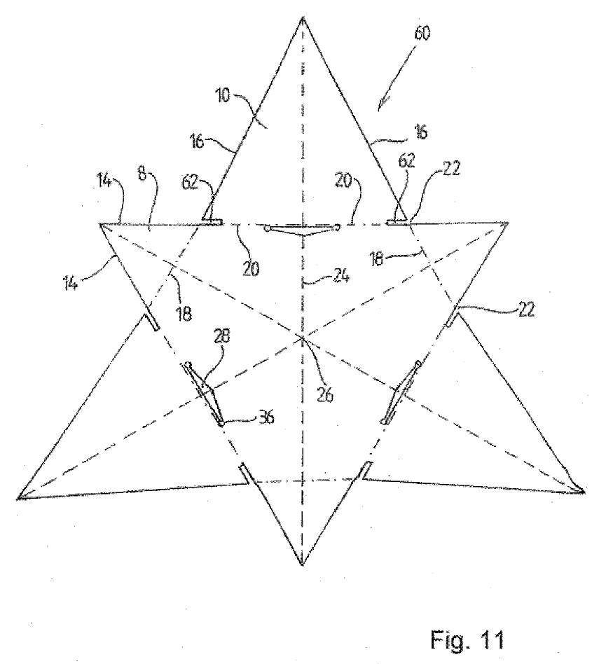

Furthermore, the folded star 2 can be provided with a larger or smaller number of larger and smaller points 8, 10 by providing the blanks 4, 6 with a total of ten or twelve points 8, 10 or any arbitrary even number of points 8, 10, instead of four larger points 10 and four shorter points 8 and joining these together in the manner described above. A folded star 2 produced in this way with a total of ten longer points 10 is shown in FIG. 9, while FIG. 10 shows a six-point folded star 2 with six longer points 10 and FIG. 11 shows one of the two identical blanks 58, 60 used for producing the folded star 2 shown in FIG. 10.

Apart from a different number of longer points 10 and shorter points 8, the folded star 2 shown in FIG. 10 also exhibits a few other smaller differences in comparison to the folded star 2 shown in FIGS. 1 to 5. First of all, in the case of the folded star 2 from FIG. 10, the blanks 58, 60 along each fold line 24 running diagonally through their midpoint 26, are not folded in a single direction, but in one direction along one half of the fold line 24 and in the opposite direction along the other half of the fold line 24, that is, on the other side of midpoint 26, so that an inward-folded area 44 lies diagonally across from an outward-folded area 40 and not an outward-folded area 40 as in the folded star 2 from FIGS. 1 to 5. Secondly, the longer points 10 of blanks 58, 60, provided with the slit openings 28, have at their baseline 20 two cut-outs 62 open at the edges, these extending from opposite side edges 16 of the points 10 along the baseline 20 a short distance in the direction of the neighboring front ends of the slit. openings 28. When joining the two blanks 58, 60, these cut-outs 62 can engage in each case with a corresponding cut-out 62 of the other blank 60, 58, which, in the completed folded star 2, leads to a mutual overlap of the side edges 16 of neighboring points 10 and thus it has a somewhat different appearance as a consequence. However, on the other hand, this measure also has the effect that the two blanks 58, 60 lie tighter against one another along their peripheral contacting line and due to the additional interlacing in the area of the cut-outs 62 will be held together even stronger. A similar result is achieved when the points 10 are provided with a cut-out 62 only at one of their side edges 16, which then must be arranged on the same side of all points 10.

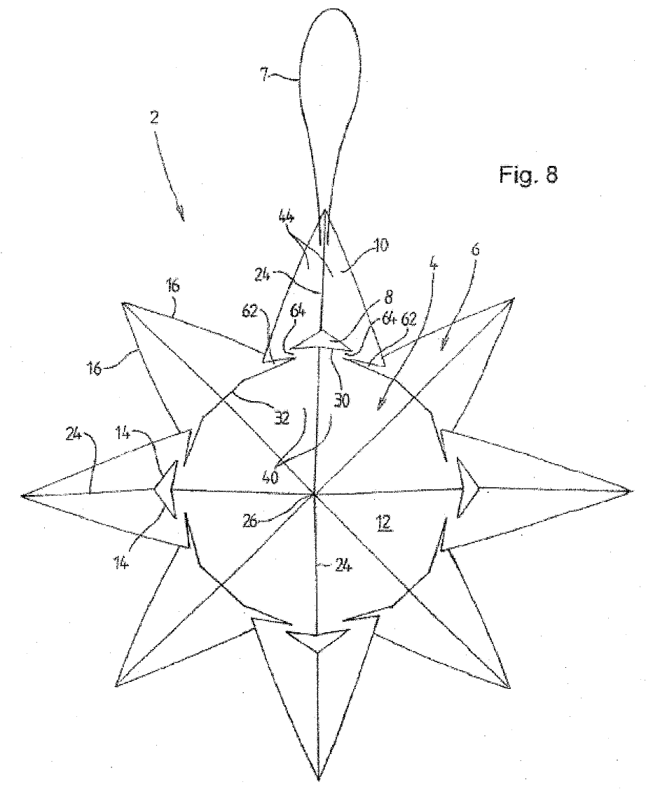

When the cut-outs 62 are lengthened to nearly the opposite front ends of the slit openings 28, as it is shown in the case of the eight-point folded star 2 in FIG. 8, the tips of the larger points 10 can be turned down or refolded on the other side of the slit openings 28 along their fold lines 24. Then the two flanks of the points 10 form an inward-folded area 44 on the other side of slit openings 28, which is connected through two narrow material bridges 64 between the front ends of slit openings 28 and the ends of the cut-outs 62 with which an outward-folded area 40 on this side of slit openings 28 is attached. In this way, using simple means, a significantly different appearance can be produced in the perspective view (not shown).

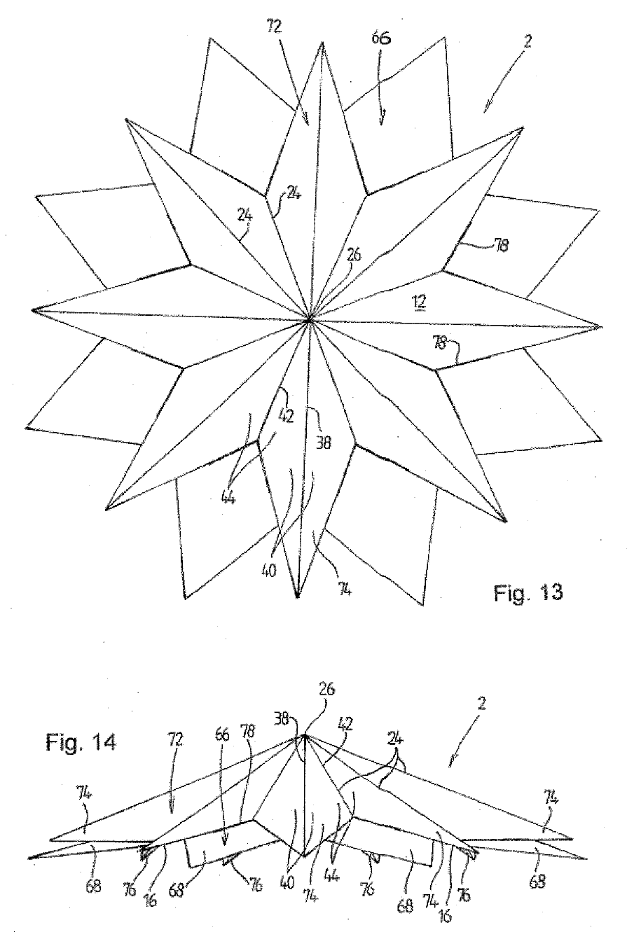

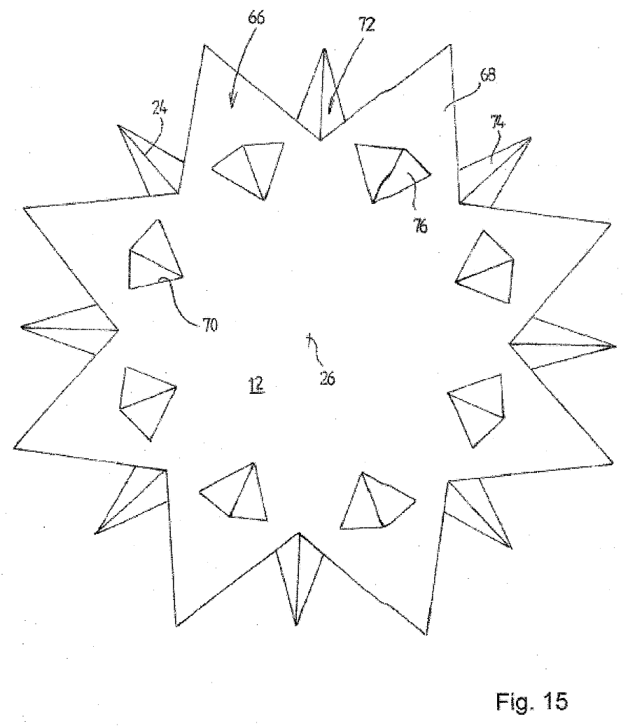

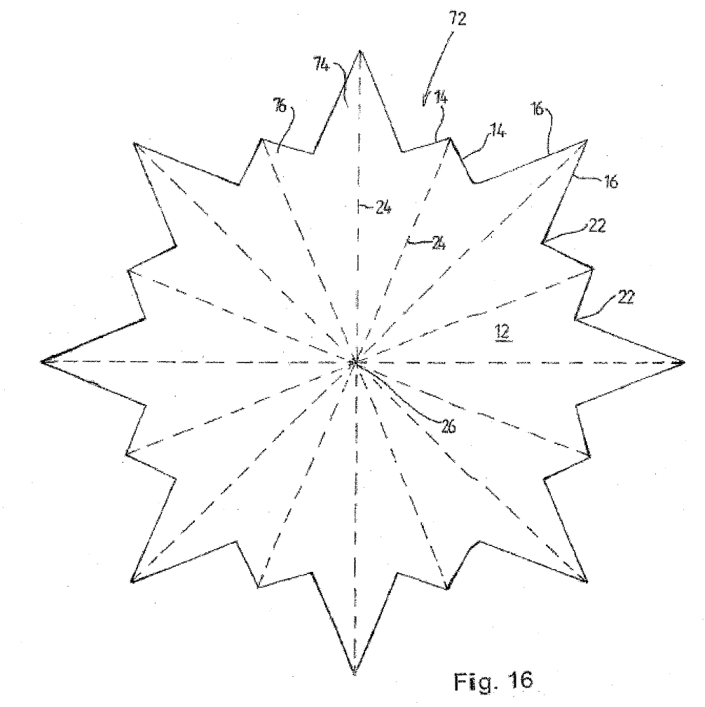

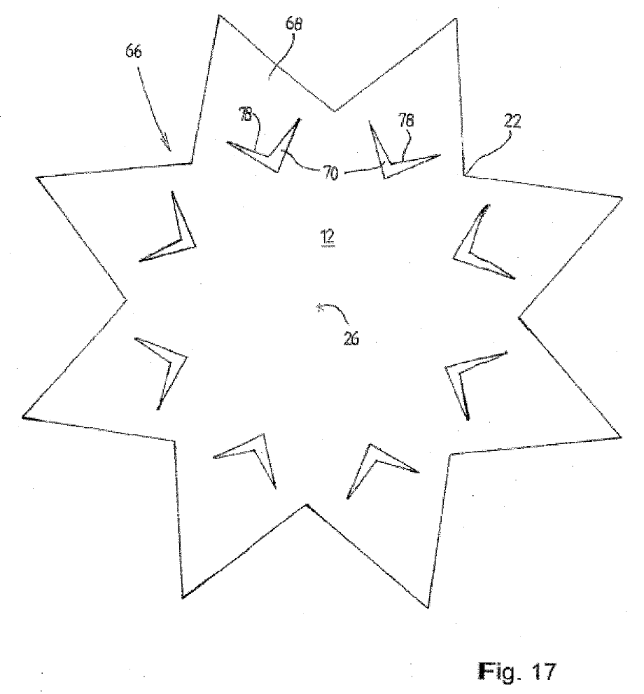

In contrast to the folded stars 2 described above, which consist of two identical blanks 4, 6 provided with fold lines 24 in each case, one of the two blanks 66 of the folded star 2 represented in FIGS. 13 to 15 is flat, as shown in FIG. 17, whereby it has a total of eight equal-sized triangular points 68 arranged at the same angular distances radially above a middle part 12 and the same number of equal-sized V-shaped slit openings 70, which are located in each case at the transition between one of the points 68 and the flat middle part 12 of blank 66 with no fold lines. As shown in FIG. 16, the other blank 72 has eight longer points 74 and eight shorter points 76 which alternate in the peripheral direction and are also arranged at the same angular distances. Apart from the fact that the number of points 74, 76 is larger than the number of points 8, 10 in the blanks 4, 6; 58, 60 described before, the blank 72 differs from these only in the fact that it has no slit opening, since these are all stamped out from the other blank 66. While the tips of the shorter points 76 arranged on the inward-folded areas 44 of this blank 72 are inserted through the slit openings 70 of the flat blank 66 and project beyond its bottom side, the longer points 74 with their tips project radially to the outside in the intermediate spaces between two adjacent points 68 of the flat blank 66, as is shown best in FIGS. 14 to 16. When viewing in the direction of the arrow in FIG. 14, thus one obtains the impression of a sixteen-point folded star with a raised middle part 12, with eight points 74 and eight flat points 68 which are arranged in the intermediate spaces between the points 74.

As can be seen best in FIG. 17, the outer bordering edges 78 of the slit openings 70 of the flat blank 64 always consist of two V-like converging halves or edge sections. The length of the two edge sections and the angle enclosed by them are preferably chosen so that the outer bordering edges 78 of the slit openings 70 of blank 66, after the joining of the two blanks 66, 72 along their entire length, lie against the flanks of the inward-folded areas 44 of the other blank 72 and are flush with the side edges 16 of the longer points converging toward the tips, as is shown best in FIG. 14. By changing the distance of the slit openings 70 from the midpoint 26 of the blank 66, the size of the projecting length of the folded blank 72 above the plane of blank 66 can be altered. If desired, in addition the contrast between the flat blank 66 and the raised folded blank 72 can be enhanced or emphasized by applying a different color to the blanks 66, 72.

Furthermore, the folded stars 2 shown in FIGS. 1 to 11 can be equipped with an additional flat blank (not shown) which is inserted between the two folded blanks 4, 6; 58, 60. The additional blank, like the blank 66 in FIG. 17, is provided with slit openings, through which all or a part of the shorter points 8 are inserted with their tip at the inward-folded areas 44 of the two other blanks 4, 6; 58, 60. The shorter points 8 can additionally be guided through a slit opening 28 in the respective other folded blank 6, 4; 60, 58 in each case, or can be anchored only in the additional flat blank, whereby this blank then holds together the two folded blanks 4, 6; 58, 60. The flat blank subdivides the cavity 52 delineated by the middle parts 12 of the blanks 4, 6; 58, 60 into two halves, but it can have an opening in the middle in case such a subdivision is not desired.

The loops of thread 7 which serve to hang the folded stars 2 and which are shown only in the case of the folded star 2 in the figures, can be glued on the folded star 2 with their thread ends next to one another using an adhesive, preferably a hot melt adhesive, as shown in FIG. 2. Alternatively, however, the loop of thread 7 can also be inserted into a small round opening (not shown) in one or both blanks 4, 6. The loop of thread is introduced expediently either in the middle of a larger point 10 or in the middle between two larger points 10.

In order to facilitate the application of the loop of thread 7, this can also be put through a V-shaped cut-out symmetrically to fold line 38, converging toward middle part 12, in one of the larger points 10.

The folded stars 2 can be made in different sizes and are used preferably for Advent or Christmas decoration, for example as window stars or as tree ornaments for a Christmas tree, but also as lanterns, as lampshade for light fixtures or as packaging containers, for example for the packaging of small objects, such as jewelry. Furthermore, a multiple number of the folded stars 2 can be lined up along a string of lights, whereby the lights are arranged inside the folded stars 2. When the folded stars 2 are made of a weather-resistant material, trees or shrubs in gardens or parks can, for example, be decorated with illuminated folded stars 2 lined up on a string of lights.

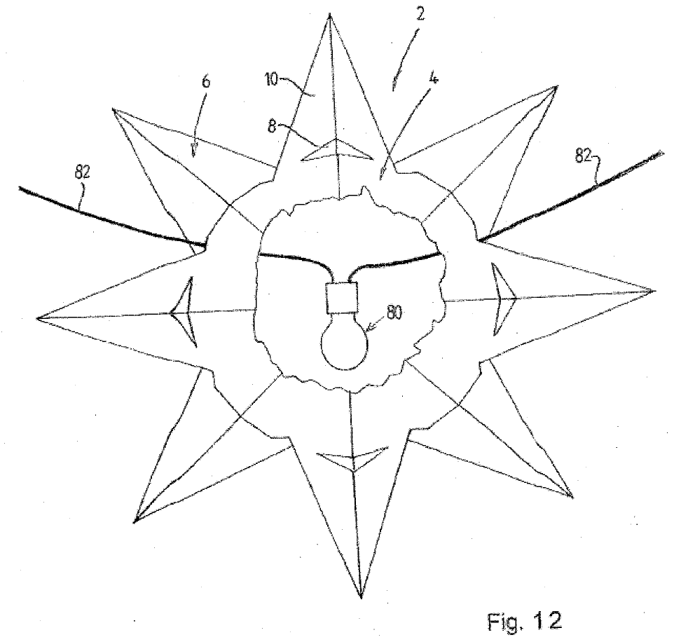

FIG. 12 shows a single folded star 2 of such a string of lights, which is made of a transparent paper or foil material. The light arranged inside it in the form of an electrical incandescent light 80 is connected through two cables 82 to a power source (not shown). The cable 82, extends from the cavity 52 enclosed by the middle parts 12 of the blanks 4, 6, in each case between two opposing re-entering corners 22 of the two blanks 4, 6, and serve at the same time for hanging the folded stars 2 of the string of lights so that loops of thread can be omitted here. Alternatively, the folded star 2 shown in FIG. 12 can also be hung as an illuminated solitary light on a single two-line cable (not shown).

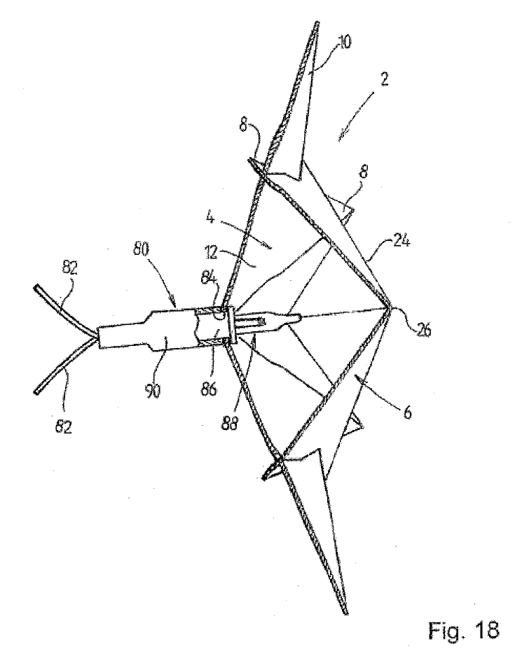

FIG. 18 shows another possibility of the combination of a folded star 2 with an electrical incandescent light 80 of a commercial string of lights. One of the blanks 4 of the folded star has there in the middle part 12 a circular opening 84 concentric to its midpoint 26 for a socket 86 for the incandescent bulb 88 of the light 80, which, after entering through the opening 84, is inserted in the known manner into a complementary lamp mounting 90 connected to the cable 82, in order to secure the edge of the opening 84 between the socket 86 and the mounting 90 before the two blanks 4, 6 are connected to one another. In order to support the attachment of the blank 4 between the socket 86 and the mounting 90, instead of the stamped round opening 84, one can also stamp radial cuts starting from the midpoint 26 with a length corresponding to the radius of the opening 84 in blank 4. In this case, the triangular sections formed between the cuts are bent to the outside of the blank 4, and when the socket 86 is inserted into the mounting 90 they are firmly secured between these two (not shown).

1. Star-shaped decorative object (2), comprising at least two blanks of material (4, 6; 5 8, 60; 66, 72) joined together, of which at least one blank (4, 6; 58, 60; 72) has a middle part (12) and a plurality of points (8, 10; 74, 76) extending outwardly beyond the middle part (12), whereby the middle part (12) is provided with several fold lines (24) running from a midpoint (26) in the direction of the points (8, 10; 74, 76) and is folded at neighboring fold lines 24 alternately in a V-shape in opposite directions so that between each two fold lines (24) separated by another fold line (24) inwardly-folded or outwardly-folded areas (44 or 40) are formed with the other fold line (24) in the middle, wherein points (8) on inwardly-folded areas (44) are inserted through openings (28, 70) of another blank (6, 4; 60, 58; 66) in order to join the two blanks (4, 6; 58, 60; 66, 72) for the formation of a hollow three-dimensional body.

2. Star-shaped decorative object according to claim 1, wherein the three-dimensional body encloses an essentially closed cavity (52).

3. Star-shaped decorative object according to claim 1, wherein at least some of the points (10; 72) on the outwardly-folded areas (40) of one of the blanks (4, 6; 58, 60; 72) are arranged between neighboring points (10) of the other blank (6, 4; 60, 58; 66).

4. (canceled)

5. Star-shaped decorative object according to claim 1, father comprising two blanks (4, 6; 58, 60), each of which has a middle part (12) provided with fold lines (24) and a plurality of points (8, 10) extending outwardly beyond the middle part (12).

6. Star-shaped decorative object according to claim 5, wherein the two blanks (4, 6; 58, 60) are essentially the same.

7. Star-shaped decorative object according to claim 5, wherein points (8, 76) on the inwardly-folded areas (44) of one of the blanks (4, 6; 58, 60) are inserted through openings (28) in the outwardly-folded areas (40) of the other blank (6, 4; 60, 58) and/or of another blank introduced between the blanks in order to join the blanks (4, 6; 58, 60) together.

8. Star-shaped decorative object according to claim 1, wherein points (8) on the inwardly-folded areas (44) are shorter than the points (10) on the outwardly-folded areas (40).

9. Star-shaped decorative object according to claim 8, wherein longer points (10) alternate with shorter points (8) and that the shorter points.(8) are inserted through openings (28) in the longer points (10).

10. Star-shaped decorative object according to claim 1, wherein at least a part of the points (8) are interlocked in openings (28) in order to make it more difficult for the points (8) to come loose from the openings (28).

11. (canceled)

12. Star-shaped decorative object according to claim 1, wherein the width of the points (8) on the inwardly-folded areas (44) is somewhat smaller or the same as the width of the points (10) on the outwardly-folded areas (40).

13. Star-shaped decorative object according to claim 1 wherein opposite side edges (14) of the points (8) that extend through the openings (28) lie on both sides of the openings (28) in line contact against the points (10) that are provided with openings.

14-15. (canceled)

16. Star-shaped decorative object according to claim 1, wherein a loop of thread (7) serving as hanger.

17. Star-shaped decorative object according to claim 1, formed at least partly of a translucent or transparent paper or foil material and having a light source (80) arranged inside it.

18-19. (canceled)

20. String of lights with a plurality of electrical lights (80) that are lined up along a common cable (82, 84) and connected through the cable (82, 84) to a power source, wherein at least part of the lights (80) are arranged inside a star-shaped decorative object according to claim 1.

21. Set of at least two blanks of material (4, 6; 58, 60; 66, 72) for the production of a star-shaped decorative object (2), whereby at least one of the blanks (4, 6; 58, 60; 72) has a middle part (12) and a plurality of points (8, 10; 74, 76) extending outwardly beyond the middle part (12), whereby the middle part (12) is provided with several fold lines (24) running from a midpoint (26) in the direction of the points (8, 10; 74, 76) so that it can be folded at neighboring fold lines (24) alternately in a V-shape, in opposite directions, whereby between each two fold lines (24) separated by another fold line (24), inward- or outward-folded areas (44 or 40) are formed respectively with the other fold line (24) in the middle, wherein at least one of the other blanks (6, 4; 60, 58; 66) has a plurality of openings (28, 70) through which points (8; 76) on inwardly-folded areas (44) of the said one blank (4, 6; 58, 60; 72) can be inserted for the formation of a hollow three-dimensional body.

22. Set of blanks according to claim 21, wherein at least one pair of essentially identical blanks (4, 6; 58, 60), each of which has a middle part (12) and a plurality of points (8, 10) extending outwardly beyond the middle part (12), whereby the middle part (12) of the two blanks (4, 6; 58, 60) is provided with several fold lines (24) running from a midpoint (26) in the direction of the points (8, 10), so that it can be folded at neighboring fold lines (24) alternately in a V-shape in opposite directions, whereby between each two fold lines (24) separated by another fold line (24) inwardly- or outwardly-folded areas (44 or 40) are formed, respectively, with the other fold line (24) in their middle, and whereby each of the blanks (4, 6; 58, 60) has a plurality of openings (28) through which the points (8) on inwardly-folded areas (44) of the respective other blank (6, 4; 60, 58) can be inserted for the formation of a three-dimensional body.

23. (canceled)

24. (canceled)

25. Set of blanks according to claim 21, wherein at least a part of the openings are formed as slit openings (28, 70).

26. Set of blanks according to claim 21, wherein at least a part of the openings (28) are symmetrical to a fold line (24).

27. (canceled)

28. Set of blanks according to claim 21, wherein at least a part of the openings (28, 70) have a V-shaped opening cross-section.

29-30. (canceled)

31. Set of blanks according to claim 21, wherein the fold lines (24) run from the midpoint (26) radially or spirally outward.

32. Method for the production of a star-shaped decorative object (2) in which blanks (4, 6; 58, 60; 66, 72) are stamped out from a sheet material, wherein at least one of the blanks has a middle part (12) and plurality of points (8, 10; 74, 76) projecting beyond the middle part (12), whereby the middle part (12) is provided with several fold lines (24) running from a midpoint (26) in the direction of the points (8, 10; 74, 76) and is folded on neighboring fold lines (24) alternately in a V-shape, in opposite directions, so that between each two fold lines (24) separated by another fold line (24), inwardly- or outwardly-folded areas (44 and 40), respectively are formed with the other fold line (24) in their middle, wherein points (8; 76) on inwardly folded areas (44) of the folded blank (4, 6; 58, 60; 72) are inserted through openings (28, 70) of at least one other blank (6, 4, 60, 58; 66) in order to join together the two blanks (4, 6; 58, 60; 66, 72) for the formation of a hollow three-dimensional body.

33. Method according to claim 32, wherein two identical or essentially identical blanks (4, 6; 58, 60) are joined together, both of which have a middle part (12) provided with fold lines (24) and points (8, 10) projecting beyond the middle part (12), and that points (8) on inwardly-folded areas (44) of one of the blanks (4, 6; 58, 60) are inserted through openings (28) in outwardly-folded areas (40) of the other blank (6, 4; 6, 58), in order to join the two blanks (4, 6; 58, 60) together.

34. Method according to claim 32, wherein the blanks to be joined together (4, 6; 58, 60; 66, 72) are brought into a position in which the points (8; 76) on the inwardly-folded areas (44) of the one blank (4, 6; 58, 60; 72) oppose openings (28; 70) in the other blank (6, 4; 60, 58; 66) and that the two blanks (4, 6; 58, 60; 66, 72) are then moved towards one another along a line running through their midpoints (26) in order to introduce the points (8, 76) on the inwardly-folded areas (44) into the openings (28; 70) essentially simultaneously.

35. (canceled)

36. Star-shaped decorative object (2), comprising at least two blanks (4, 6; 58, 60; 66, 72) joined together, of which at least one blank (4, 6; 58, 60; 72) has a middle part (12) and a plurality of shorter and longer points (8, 10; 74, 76) extending outwardly beyond the middle part (12), whereby the middle part (12) is provided with several fold lines (24) running from a midpoint (26) in the direction of at least the longer points (10; 74) and is folded at the fold lines (24) running from the midpoint (26) in the direction of said longer points (10; 74) in a V-shape, so that between two neighboring of said fold lines (24) running from the midpoint (26) in the direction of said longer points (10; 74) inwardly-folded areas (44) are formed, wherein the shorter points (8) located on the inwardly-folded areas (44) are inserted through openings (28, 70) of another blank (6, 4; 60, 58; 66) in order to join the two blanks (4, 6; 58, 60; 66, 72) for the formation of a hollow, three-dimensional body.

37. Set of at least two blanks (4, 6; 58, 60; 66, 72) for the production of a star-shaped decorative object (2), whereby at least one of the blanks (4, 6; 58, 60; 72) has a middle part (12) and a plurality of shorter and longer points (8, 10; 74, 76) extending outwardly beyond the middle part (12), whereby the middle part (12) is provided with several fold lines (24) running from a midpoint (26) in the direction of at least the longer points (10; 74), so that it can be folded at the fold lines (24) running from the midpoint (26) in the direction of said longer points (10; 74) in a V-shape, whereby between two neighboring of said fold lines (24) running from the midpoint (26) in the direction of said longer points (10; 74) inwardly-folded areas (44) are formed, wherein at least one of the other blanks (6, 4; 60, 58; 66) has a plurality of openings (28, 70) through which the shorter points (8; 76) located on the inwardly-folded areas (44) of the said one blank (4, 6; 58, 60; 72) can be inserted for the formation of a hollow three-dimensional body.
